(19) United States
(12) Patent Application Publication
(10) Pub. No.: US 2025/0390858 A1
(43) Pub. Date: Dec. 25, 2025

(54) CODELESS PAYMENT INTERFACE

(71) Applicant: Paypal, Inc., San Jose, CA (US)

(72) Inventors: Perumal Palani, Gilroy, CA (US); Rachna Tibrewala, San Jose, CA (US); Jeeva Gautam Chinnacuttygounder Krishnaswami, Newark, CA (US); Vikram Venkataraman, San Francisco, CA (US)

(21) Appl. No.: 19/243,990

(22) Filed: Jun. 20, 2025

Related U.S. Application Data
(60) Provisional application No. 63/662,230, filed on Jun. 20, 2024.

(51) Int. Cl. G06Q 20/32; G06Q 20/38; G06Q 20/40

(52) U.S. Cl. CPC G06Q 20/325; G06Q 20/3829; G06Q 20/40; G06Q 2220/00

(57) ABSTRACT

The disclosed computer-implemented method may include generating an interface code configured to connect to a payment server and generating, in response to loading a merchant website hosted on a merchant server that integrates the interface code, a payment interface with the interface code. The interface code may bypass the merchant server to connect to the payment server. The method may also include completing a payment using the payment interface that bypasses the merchant server to connect to the payment server. Various other methods, systems, and computer-readable media are also disclosed.

### CROSS REFERENCE TO RELATED APPLICATION

This application claims the benefit of U.S. Provisional Application No. 63/662,230, filed 20 Jun. 2024, the disclosure of which is incorporated, in its entirety, by this reference.

### TECHNICAL FIELD

This application relates to user interfaces. More specifically, this application relates to dynamically generated and loaded payment user interfaces.

### BACKGROUND

Merchant websites often utilize payment services to provide customers with various payment options. The payment services are often integrated into the merchant website. However, certain payment service interfaces integrated in this way may present certain security vulnerabilities and/or website compatibility issues.

As referred to herein artificial intelligence (AI) generally refer to machines (e.g., software and/or hardware) developed to think and/or act like humans. Further, although the examples herein relate to AI and/or machine learning (ML) models (e.g., programs and/or systems trained from input data to output predictions or decisions, including unsupervised, supervised, and/or reinforcement learning models), the AI/ML models referred to herein may correspond to any type of AI technology, including various types of machine learning, neural network (NN) (e.g., having a structure of input layers, one or more hidden layers, and an output layer, each layer performing calculations with input from a previous layer using trained/learned weights), deep learning (DL) (e.g., NN with more than three hidden layers), generative AI (GenAI) (e.g., AI trained to generate content such as text, images, video, audio, etc. as learned from existing content), large language model (LLM) (a GenAI for natural language processing to generate human-like text), etc. (e.g., any other AI model).

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1 is a simplified diagram of an exemplary payment interface generation.

FIG. 2 is a simplified communication diagram of an exemplary button code generation.

FIGS. 3A-B is a simplified diagrams of exemplary architectures for a codeless payment interface.

FIGS. 4A-B are diagrams of exemplary payment interfaces.

FIG. 5 is a diagram of an exemplary workflow for a codeless payment interface.

FIGS. 6A-C are communication diagrams for a codeless payment interface.

FIG. 7 is a block diagram of an exemplary system for a codeless payment interface.

FIG. 8 is a block diagram of an exemplary network for a codeless payment interface.

FIG. 9 is a flow diagram of an example method for a codeless payment interface.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE EMBODIMENTS

The present disclosure is generally directed to a codeless payment interface. As will be explained in greater detail below, embodiments of the present disclosure may use code used, determined, and/or generated by a payment service that may be integrated with a merchant website. The code may bypass communicating with/through the merchant server and directly to the payment server (e.g., from client device/browser to payment server), and further, may communicate in a secure way. The code refers to various implementations and/or combinations of source code (in any programming language such as C#, Java, JavaScript, markup language, etc.), object code, script, code snippet, and/or executable code, as well as any supporting data such as configuration data, metadata, among others.

Features from any of the embodiments described herein may be used in combination with one another in accordance with the general principles described herein. These and other embodiments, features, and advantages will be more fully understood upon reading the following detailed description in conjunction with the accompanying drawings and claims.

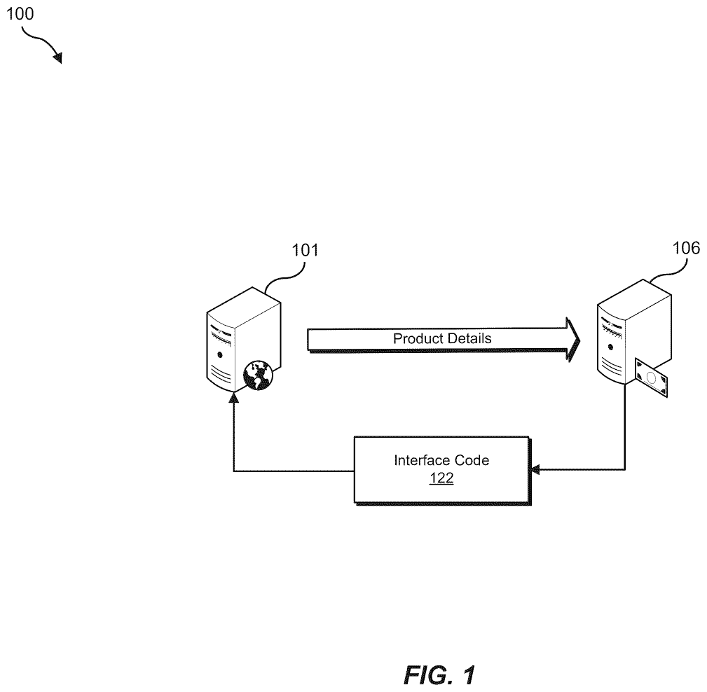

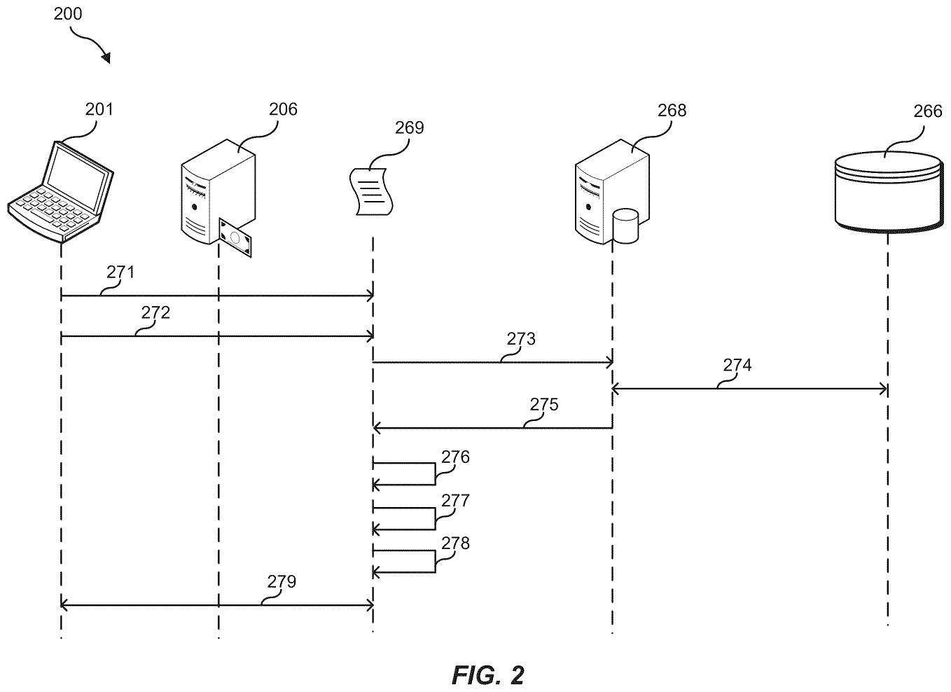

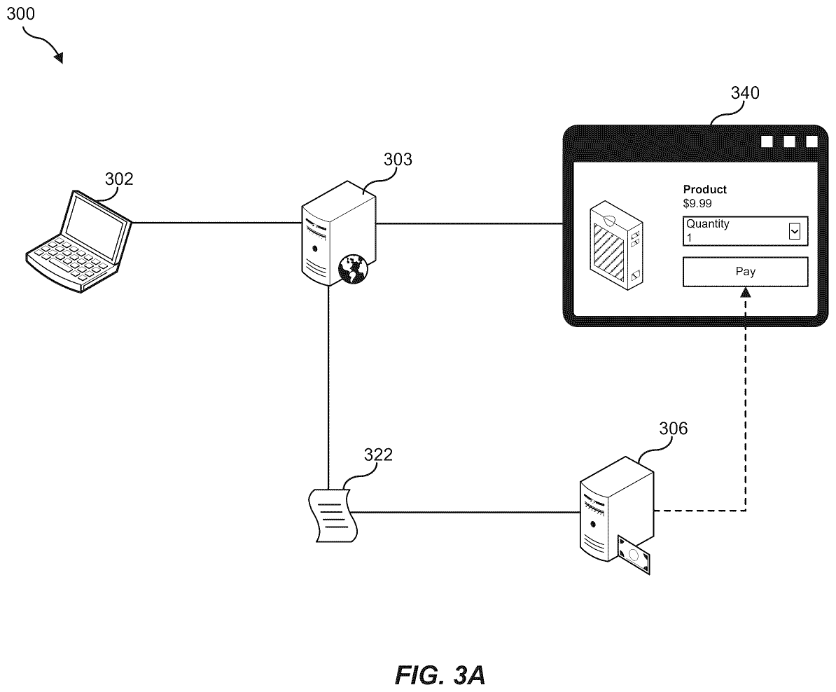

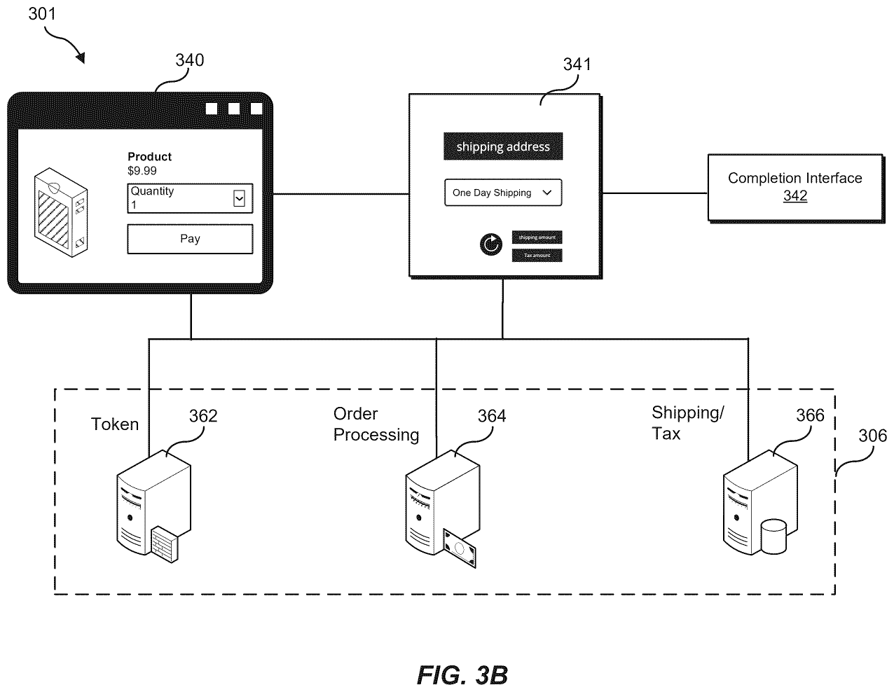

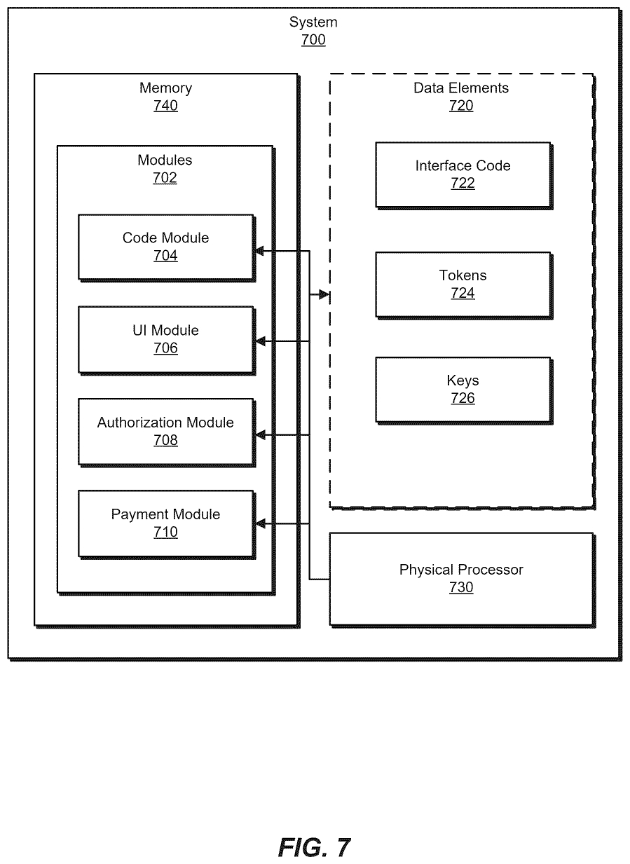

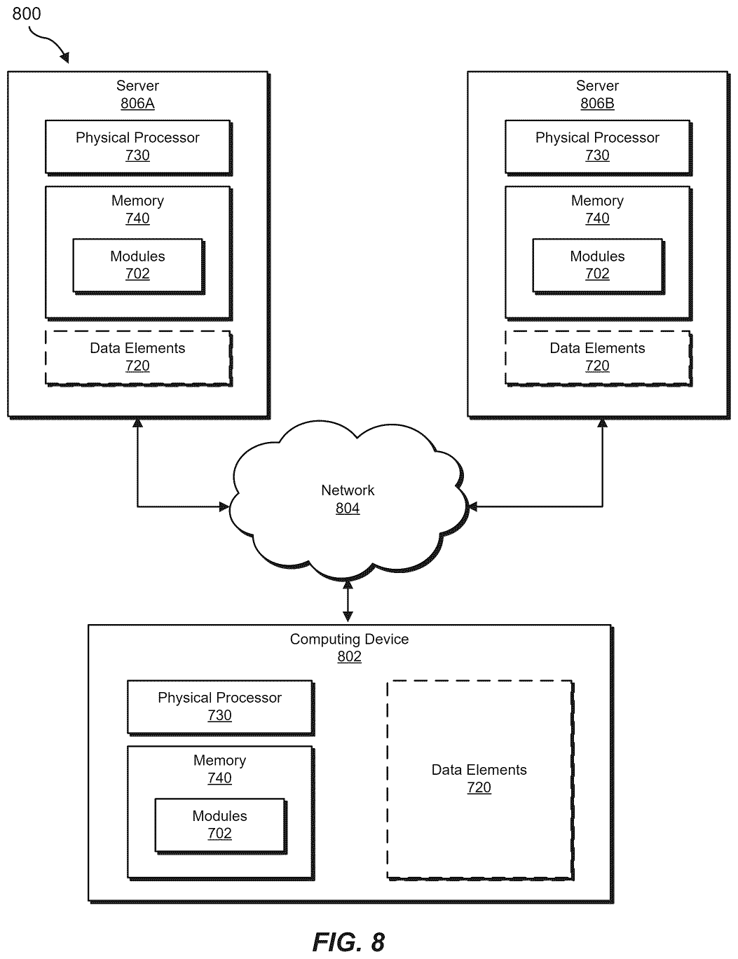

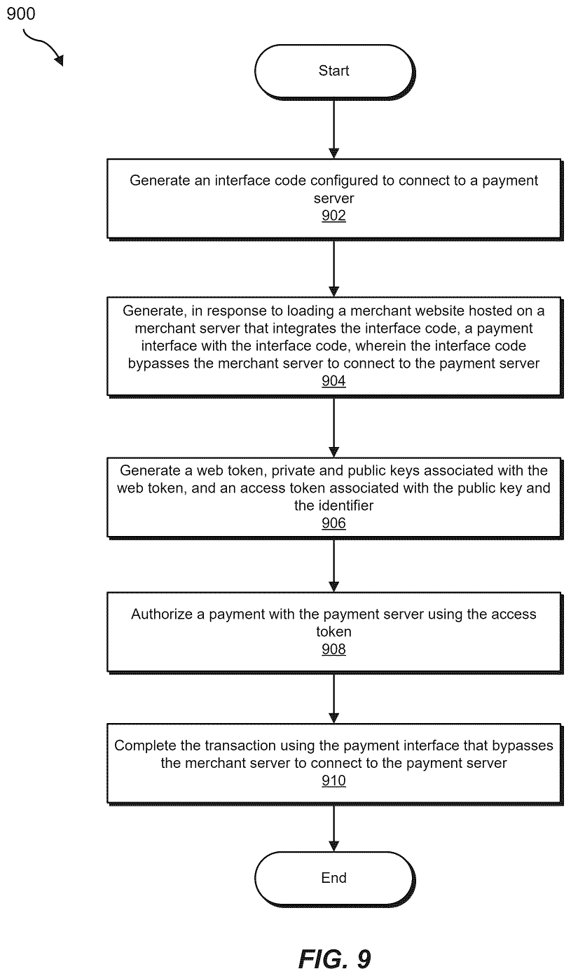

The following will provide, with reference to FIGS. 1-9, detailed descriptions of codeless payment interfaces. Detailed descriptions of various architectures will be provided in connection with FIGS. 1, 3A-3B. Detailed descriptions of example flows will be provided in connection with FIGS. 2, 4A-4B, 5, and 6A-6C. Detailed descriptions of example systems will be provided in connection with FIGS. 7-8. In addition, detailed descriptions of example related methods will be provided in connection with FIG. 9.

FIG. 1 illustrates an example environment 100 for a codeless payment interface (also referred to as a button or no code button herein) that may allow a website to include a payment interface (e.g., for a separate payment service) without having to insert the payment interface code into the website's code. A merchant 101 may request, from a payment service server 106, an interface code 122 to add codeless payment interface functionality to a website for merchant 101. As will be described further below, the request may include details relating to the website (e.g., a product to be displayed on the website, a visitor of the website, merchant 101, related accounts with respect to the payment service, etc.) which payment service server 106 may use to generate and provide interface code 122 to merchant 101. In some implementations, interface code 122 may include code for the payment interface. For example, interface code 122 may include the actual code for the payment interface, which the website may dynamically insert for rendering in a browser of a user/visitor. In other examples, interface code 122 may include code for a framework of the payment interface, for example serving as a placeholder to allow additional code to be dynamically retrieved and loaded (e.g., from different servers).

In some implementations, interface code 122 may not include actual code for a payment interface. Instead, interface code 122 may include identifiers, application programming interface (API) calls, parameters, metadata, and/or links usable for accessing the payment interface from the website, which in some examples may be a popup or separate website. For example, interface code 122 may include one or more identifiers (e.g., as a code or button ID identifying the code or button, which may be associated with merchant 101) and may further include API calls to a payment service (e.g., one or more servers such as payment service server 106, other payment servers and/or authorization servers associated with the payment service). Merchant 101 may integrate interface code 122 into the merchant's website (e.g., code that may reside in a merchant server or server associated with the merchant). A user's browser, when loading/running interface code 122, may contact payment service server 106 (e.g., bypassing the merchant server) to generate the payment interface in the browser, without the merchant server having to host/provide code for the payment interface. In some examples, merchant 101 may provide certain information, such as product details, to customize interface code 122 for integration into a specific page (e.g., product page) of the merchant's website.

FIG. 2 illustrates an example environment 200 for generating a codeless payment interface. A merchant 201 (e.g., corresponding to merchant 101, and may further correspond to a merchant's website that may be visited by a user) may request the codeless payment interface from a payment service server 206 (e.g., corresponding to payment service server 106, which may represent one or more servers) and in some implementations, merchant 201 may be logged into an account with payment service server 206. At step 271, merchant 201 may visit a UI generator 269 (e.g., a user interface that may allow merchants to preconfigure parameters for customizing and generating an interactive graphical element such as a button, which in some implementations may be hosted on a server of payment service server 206) which in some examples may be hosted by a server of payment service server 206.

UI generator 269 may allow, at step 272, merchant 201 to provide product details and checkout customizations. For example, merchant 201 may provide details on products/services that may be paid for using the to-be-generated button, such as descriptions/attributes, price options (e.g., different prices for different sizes/models, etc.), payment options, as well as checkout customizations, such as interface customizations (e.g., options for drop-down menus for prices, other user interface element customizations), type of button (e.g., displayed as a button, a QR code, a link, etc.) and other options. In some implementations, merchant 201 may provide customizations for each product, although in other implementations, a template may be used for applying to multiple/all products. Although the specification refers to a button, other implementations of the interactive graphical element are contemplated and fall within examples/implementations of a button (and the term button is meant to be used interchangeably with these other implementations). For example, the interactive graphical element can be implemented as a pop-up window, as an overlay within the same viewing area, a link, a QR or other code). The interactive graphical element can also use an NFC, blue-tooth, and/or other short range wireless technology.

At step 273, UI generator 269 (e.g., the server hosting UI generator 269) may provide (e.g., send or otherwise make accessible) a payload (e.g., product details and checkout customizations) to a hosted button service 268 (e.g., a software service for generating the codeless payment interface that in some examples may be hosted by a server of payment service server 206). At step 274, hosted button service 268 may provide the product details and customizations to a data store 266 (e.g., a server for storing data such as profile data and in some examples may be hosted by a server of payment service server 206). This data may also be associated with a button ID created by hosted button service 268 at step 275.

At step 276, button code may be generated (e.g., a script or other code that may be integrated into a website of merchant 201 for the codeless payment interface). At step 277, a payment link may be generated. At step 278, a QR code may be generated. One or more of steps 276-278 may be optional and may be performed based on the checkout customizations (e.g., whether the options for generating the button code, payment link, and/or QR code were selected). Moreover, although button code and interface code are used interchangeably herein, in some examples the button code/interface code may refer to one or more of the options generated at steps 276-278 (e.g., button code, payment link, and/or QR code).

At step 279, merchant 201 may request, retrieve, access, or otherwise use the button code generated at steps 276, 277, and/or 278. As will be described further below, merchant 201 may integrate the button code into a website of merchant 201 as hosted by a server of merchant 201. For example, the button code may be included in the website (e.g., by integrating the button code into the website code) such that when the website is loaded in a user's browser, the button code may have an appropriate payment interface to be rendered in the merchant's website, such as presenting one or more UI elements (e.g., as a the payment interface within a section of the website), as a link (e.g., allowing the user to navigate to the payment interface), as a QR code (e.g., allowing the user to navigate to the payment interface), and/or a combination thereof.

FIG. 3A illustrates an example environment 300 for using a codeless payment interface. For instance, a buyer (e.g., a user/person, an autonomous agent, and/or other entity capable of initiating transactions) may visit a merchant website. A buyer device 302 (e.g., a computing device capable of accepting user input and/or other inputs) may visit (e.g., using a browser on buyer device 302) a merchant website 303 (hosted by a merchant server) that has integrated an interface code such as an interface code 322. Interface code 322 may connect to payment service server 306 for generating a payment interface 340 to be presented to and used by buyer device 302 (on the browser of buyer device 302). Interface code 322, running on the browser of buyer device 302, may connect to payment service server 306 without having to connect to the merchant server.

Generating payment interface 340 may include, for example, fetching (from payment service server 306 and more specifically a data store such as data store 266) product details based on a code ID associated with interface code 322 (and/or the merchant) to customize aspects of payment interface 340, such as product details (name, price, select list, customer-entered price, other fields, etc.). Interface code 322 may also obtain payment methods from payment service server 306 that may be suitable for the transaction (which in some examples may be based on the merchant and/or buyer device 302 and may also be retrieved from data store 266) and may further consider other factors, such as buyer location, merchant preference, currency, etc. Based on these payment options, payment interface 340 may include appropriate UI elements, such as buttons. Payment interface 340 may further interface with payment service server 306 for completing the transaction. Interface code 322 and/or payment interface 340 may communicate to payment service server 306 (and/or other servers associated with the payment service) as needed to generate UI elements, authorize/authenticate users/devices, and perform payment transactions. Accordingly, interface code 322 (e.g., payment interface 340) may process and/or execute payment on the client's browser securely without need of the merchant server. For example, interface code 322 and/or payment interface 340 may have pre-loaded or otherwise be preconfigured with certain information directly or indirectly from the merchant server, such as merchant account information (e.g., identifiers, locations/addresses, financial institutions, etc.), product information (e.g., identifiers, descriptions, categories, prices, etc.), buyer information (e.g., identifiers, locations/addresses, associated accounts/information with the merchant, etc.), transaction related information (e.g., shipping, taxes, promotions/discounts, adjustments, etc.) such that interface code 322 and/or payment interface 340 may not directly request this information from the merchant server to process payment. In other examples, this information may be available from or otherwise be accessible to payment service server 306 (e.g., as may have been previously configured as in FIG. 2) without having to communicate with the merchant server. The payment may be processed without further input from and/or input to the merchant server. In other words, buyer device 302 may bypass the merchant server and communicate with payment service server 306.

FIG. 3B illustrates a purchase environment 301 for completing a purchase using payment interface 340. As further illustrated in FIG. 3B, payment service server 306 may include, integrate, and/or otherwise represent multiple different types of servers, including an authorization server 362 (e.g., a server and/or service on a server for performing authorization/authentication operations), a payment server 364 (e.g., a server and/or service on a server for performing/completing financial transactions), and a profile server 366 (e.g., a server and/or service on a server for managing profile data and in some examples correspond to data store 266).

Payment interface 340 (e.g., based on interface code 322 as in FIG. 3A) may connect with authorization server 362 to create an access token that authenticates the user's browser for subsequent payment service API calls. A checkout interface 341 allows the user to complete other details for completing the purchase/payment transaction. For example, the user's browser may connect to payment server 364 for order processing details, such as payment options/details, connecting to the user's account, etc. In addition, merchants may have the flexibility to configure a wide range of shipping and tax rules on their profiles (e.g., as configured and stored in data store 266 as described above). These rules may be retrieved from profile server 366 and applied during the user's (e.g., buyer) checkout process, as in checkout interface 341, ensuring that the accurate shipping and tax amounts are calculated.

Once the details are finalized, the user may accept and complete the purchase. Payment server 364 may use the approved details from checkout interface 341 to complete financial transactions as needed. In some examples, a completion interface 342 may optionally be presented.

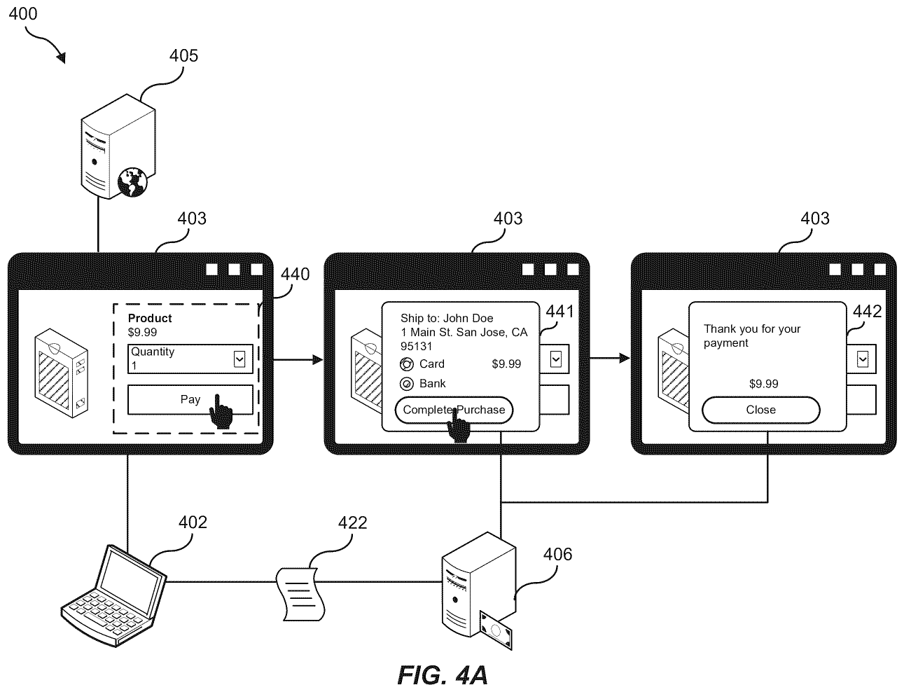

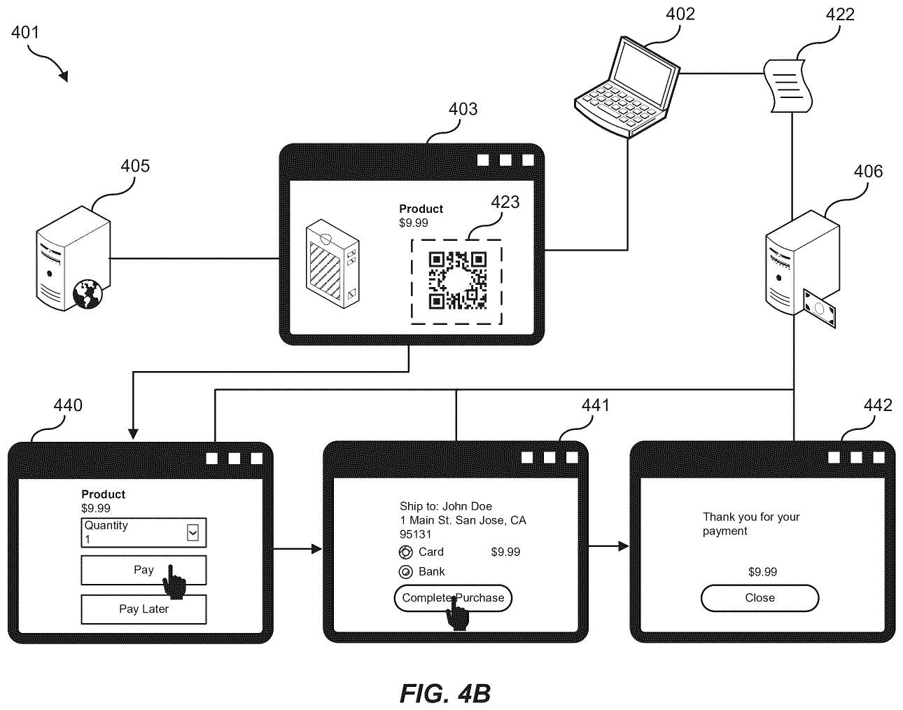

FIG. 4A illustrates an environment 400 of an example payment UI 440 presented to a buyer device 402 (corresponding to buyer device 302). For example, when a buyer (e.g., a user or other agent) uses buyer device 402 to visit a merchant website 403 hosted on a merchant server 405 (e.g., a server associated with the merchant) having an interface code 422 (corresponding to any interface code described herein, such as interface code 322), buyer device 402 may load or otherwise execute, for example in a browser or other application, interface code 422 that may generate payment UI 440 (corresponding to any payment interface described herein, such as payment interface 340) loaded into the browser from a payment service server 406 (e.g., corresponding to payment service server 306) with corresponding purchase details. Buyer device 402 may use payment UI 440 to complete a purchase (or otherwise make a payment). In FIG. 4A, payment UI 440 may include a button or link (e.g., corresponding to a particular payment service) that may separately open a checkout interface 441 (e.g., checkout interface 341, corresponding to a popup or a separate website) having checkout details for the selected payment service, and once buyer device 402 approves (e.g., sends an approval) and completes the purchase/transaction, a completion interface 442 (e.g., completion interface 342) may be presented.

FIG. 4B illustrates another environment 401 of payment UI 440. In FIG. 4B, interface code 422 may generate (e.g., when the merchant website is loaded in the browser of buyer device 402) a QR code 423 (representing any code or link for accessing a separate website or application), which buyer device 402 may use to navigate to or otherwise access payment UI 440 (e.g., the separate website or application) loaded with corresponding purchase details to complete a purchase (or otherwise make a payment). In FIG. 4B, payment UI 440 may be loaded into the browser of buyer device 402 from payment service server 406 as a separate website/interface than merchant website 403. Buyer device 402 may use payment UI 440 to select a specific payment service, leading to checkout interface 441 having checkout details for the selected payment service, and once buyer device 402 approves (e.g., sends an approval) and completes the purchase/transaction, completion interface 442 may be presented.

In some examples, different payment methods may be available, including different forms of payment (e.g., different credit cards, bank accounts, etc.), different payment services, and/or different payment products (e.g., buy now pay later options, gift cards, reward points, etc.). Payment service server 406 may determine (e.g., based on the user and/or merchant) which payment methods are available and accordingly present corresponding user interface elements, as illustrated in FIGS. 4A-4B.

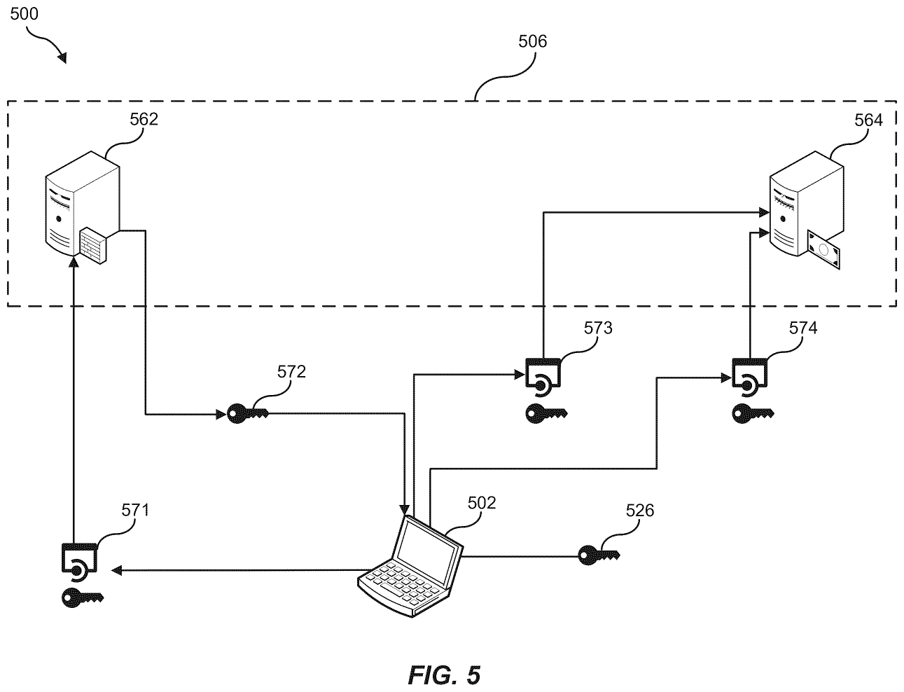

FIG. 5 illustrates a flow 500 of an example process of making a purchase/payment using an interface code and payment interface as described herein. A buyer, using client browser 502 (e.g., on a client device of the buyer) may visit a merchant website (e.g., merchant website 403) that integrates a button code, as described herein, such that a payment interface (e.g., payment UI 440) is rendered on client browser 502 (e.g., as part of the merchant website, as separately navigated to by the buyer, etc.). The buyer may then click on the payment interface (e.g., a button thereof) to initiate a series of API operations for a payment service server 506 (corresponding to payment service server 306) that includes an authorization server 562 (corresponding to authorization server 362) and a payment server 564 (corresponding to payment server 364). Step 571 may correspond to an access token request using an appropriate API. The codeless payment interface architecture described herein (e.g., interface code, payment interface, and corresponding backed services) may use an authentication protocol, such as OAuth2 DPOP (Demonstrating Proof of Possession) or another proof of possession protocol such as mutual TLS Authentication (mTLS). For example, private and public keys 526 generated by client browser 502 may be securely stored in a browser storage of client browser 502. The public keys may be sent to authorization server 562. A web token (such as JSON Web Token in accordance with DPoP), may be generated (based on the public key) and added to a request header when connecting to authorization server 562. This web token may be used by authorization server 562 to generate a valid access token.

Step 572 may correspond to an access token response. Authorization server 562 may generate an access token that is associated with the public key of the web token. The public key may be persistently stored for subsequent API call validations.

Step 573 may correspond to a payment order request. Using the access token (bound to the public key) and a button ID info (e.g., from the interface code and may be associated with a merchant), an order request may be generated and sent to payment server 564 for creating an order (e.g., the user initiating a purchase using payment UI 440). An order response may be passed back to the caller (e.g., the interface code/payment interface and/or corresponding backend server/service) for invoking respective payment method handlers (e.g., corresponding to different payment options), for presenting to the buyer for approval (e.g., the buyer selecting/approving one of the payment options).

Step 574 may correspond to a payment order fulfillment. When the buyer approves (e.g., using checkout interface 441), an order fulfillment API call with the payment service (e.g., payment server 564) may capture final payment for completing the order.

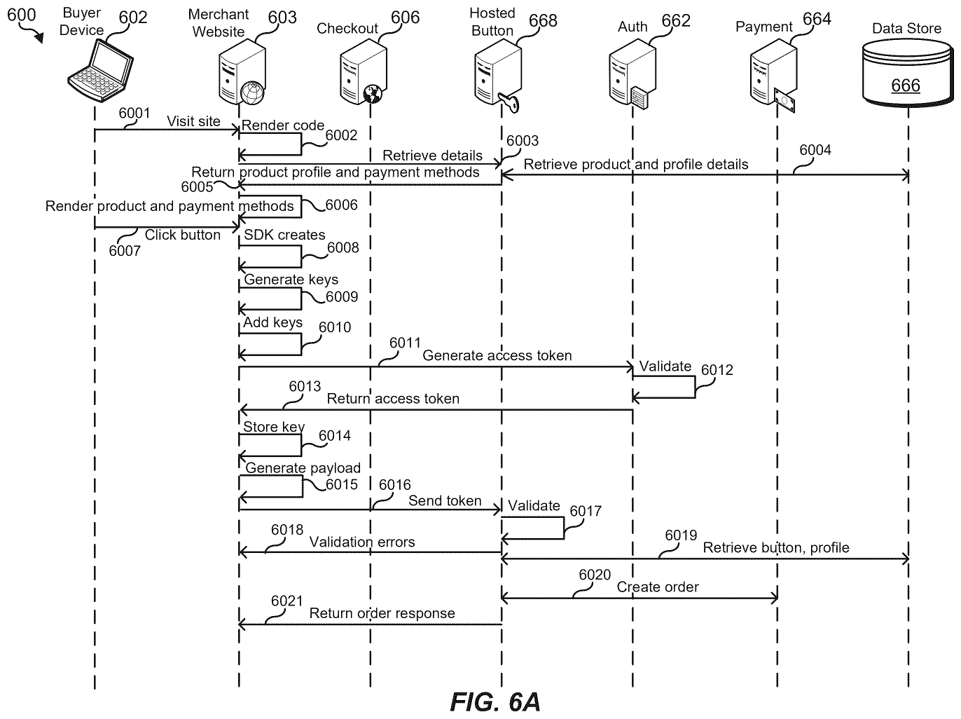

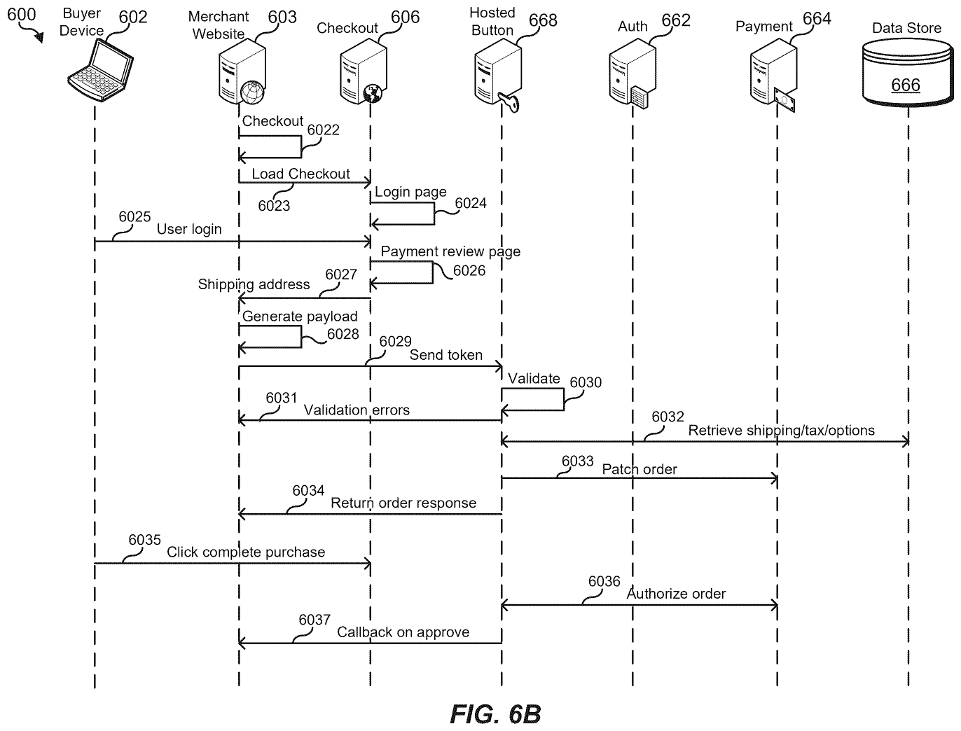

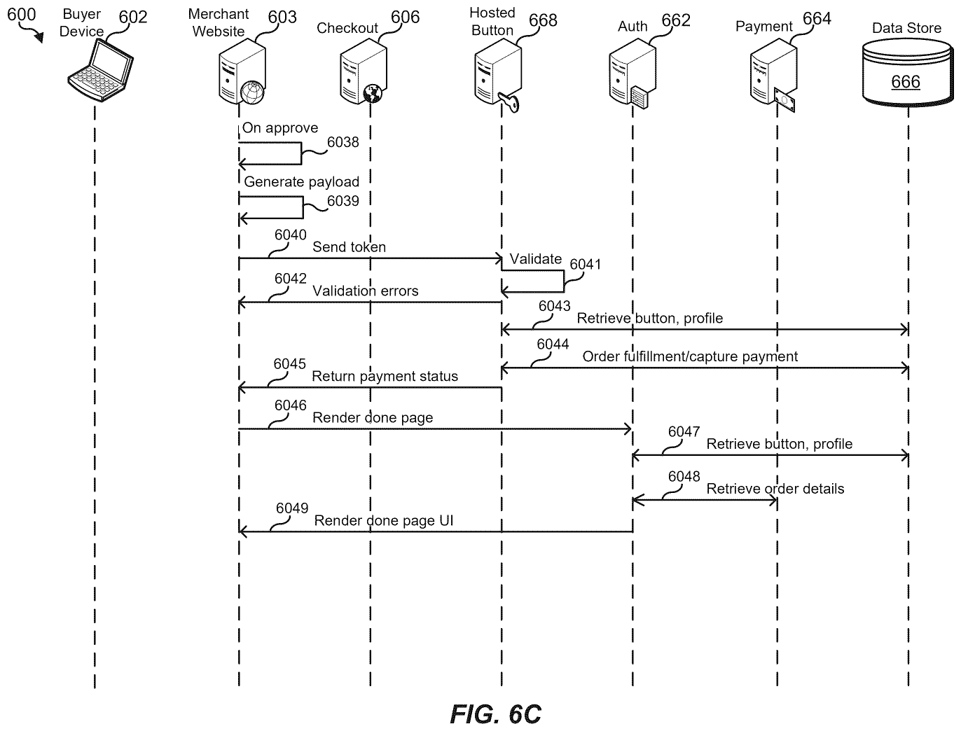

FIGS. 6A-6C illustrate an example flow 600 for a buyer device 602 (e.g., buyer device 302 or other computing device allowing a user and/or other autonomous agent to provide user inputs and initiate transactions), a merchant website 603 (e.g., merchant website 303 and generally corresponding to a merchant server for hosting a merchant website), and a payment service 606 (e.g., payment service server 306) that includes a hosted button service 668 (e.g., hosted button service 268), an authorization service 662 (e.g., authorization server 362), a payment order service 664 (e.g., payment server 364), and a data store 666 (e.g., data store 266).

At step 6001, buyer device 602 visits merchant website 603 using a browser or other application (e.g., an application that may be hosted by the merchant server represented by merchant website 603), which at step 6002 renders the button code (e.g., interface code previously generated as described herein). Continuing to a product rendering phase (steps 6003-6006) corresponding to payment interface 340, at step 6003, using a corresponding button id (e.g., an interface identifier), the browser (showing merchant website 603) may retrieve product details and payment methods from hosted button service 668, which in turn at step 6004 may retrieve the product and profile details stored in data store 666. At step 6005, the product, profile, and payment methods are returned to the browser, which at step 6006, gets rendered as part of the payment UI.

Once the details are rendered and presented to buyer device 602, at step 6007 buyer device 602 may click (e.g., receive a user input for) a payment button (e.g., selecting a particular payment method/service) for starting an order, which may trigger a payment UI as described herein. Continuing to a context creation phase (steps 6008-6021) corresponding to a purchase order session, at step 6008 the browser may call a create method, such as with a javascript SDK. Continuing to a DPOP token generation phase (steps 6009-6014), the browser, using the SDK, may generate a public/private key pair for use with DPOP (although in other examples, other protocols may be used) at step 6009. At step 6010, the browser may generate a token (e.g., a JSON Web Token JWT), add the public key to its header, and signs it with the private key. As step 6011, the browser adds the JWT to a DPOP request header for a DPOP request to authorization service 662, which generates an access token for the merchant's client ID with a token endpoint. At step 6012, authorization service 662 validates the signature of the JWT, and binds the public key to the access token, which at step 6013 is returned to the browser. At step 6014, the browser securely stores the private key in the browser storage. With the bounded access token, authorization service 662 may validate further interactions as coming from the browser using the access token and public key. In other words, if another agent attempts to hijack the browser's session, the other agent would not have the private key to properly sign the access token such that authorization service 662 can deny the other agent.

Continuing to step 6015, the browser generates a payload (e.g., order details and/or options selected by buyer device 602 (e.g., based on user inputs), such as quantity, model, total price, etc.). In other words, for subsequent calls, the browser may send the bounded access token to maintain secure session(s). At step 6016, the browser sends the access token and button id to hosted button service 668 to start creating the context (order). At step 6017, hosted button service 668 validates, using the DPOP protocol, the access token (e.g., with authorization service 662 as needed), and optionally at step 6018, any validation errors are sent back to the browser (e.g., if validation failed). At step 6019, hosted button service 668 retrieves profile details, based on the button ID, from data store 666, and at step 6020, performs a create order operation with payment order service 664, which establishes a context ID for the order. Hosted button service 668 returns the order response (e.g., context ID) back to the browser at step 6021.

Moving on to FIG. 6B, a buyer approval phase (steps 6022-6037) corresponding to checkout interface 341 begins at step 6022, where the browser invokes a checkout operation after successfully receiving the context ID. Accordingly, at step 6023, the browser loads a checkout interface, which payment service 606 renders at step 6024. At step 6025, buyer device 602 logs into payment service 606 (e.g., also bypassing the merchant server). At step 6026 (e.g., after successful login), payment service 606 renders the payment review page for display to buyer device 602 via the browser.

Continuing to a shipping/tax calculation phase (steps 6027-6034), payment service 606 optionally performs a shipping address change callback at step 6027. The browser generates a payload for this phase at step 6028, and then at step 6029 sends the access token with the button ID and context ID to hosted button service 668. Hosted button service 668 validates the access token at step 6030, optionally sending validation errors back to the browser at step 6031 if validation failed. At step 6032, hosted button service 668 retrieves shipping options, tax options, and related details from data store 666 (e.g., using the button ID), and at step 6033, hosted button service 668 patches the order (using the context ID) with the retrieved shipping/tax options. At step 6034, hosted button service 668 returns the order response (for the context ID) back to the browser for buyer device 602 to review.

At step 6035, once buyer device 602 has reviewed/approved the final order details (e.g., represented by user inputs from the user/agent), buyer device 602 clicks the appropriate button (e.g., provides the appropriate user input) for completing the purchase, signaling payment service 606 to perform, at step 6036, authorizing the order with payment order service 664. Upon approval and completion, payment service 606 sends a callback to the browser at step 6037.

Turning to FIG. 6C and continuing to step 6038, the browser (using the JS SDK) initiates the payment process or pay context phase (steps 6039-6045). At step 6039, the browser generates a payload signed by the private key (stored in the browser) and sends the bounded access token, button ID, and context ID at step 6040 to hosted button service 668. At step 6041, hosted button service 668 validates the access token, and optionally sends validation errors at step 6042 to the browser upon failure. At step 6043, hosted button service 668 retrieves, from data store 666, profile details (e.g., of the merchant) using the button ID, and at step 6044 performs order fulfillment (e.g., captures payment from buyer device 602 to the merchant based on the retrieved profile details) with payment order service 664. Upon completion, hosted button service 668 returns the payment status to the browser at step 6045.

A next phase, displaying a done page (steps 6046-6049) corresponding to completion interface 342, starts with rendering the done page at step 6046. To do so, at step 6047 hosted button service 668 retrieves profile details from data store 666 using the button ID, and at step 6048 further retrieves order details from payment order service 664. At step 6049, hosted button service 668 returns the details to the browser for rendering, completing the purchase process.

Various systems described herein may perform the methods and processes described herein. FIG. 7 is a block diagram of an example system 700 for a codeless payment interface. As illustrated in this figure, example system 700 may include one or more modules 702 for performing one or more tasks. Modules 702 may include a code module 704 (e.g., for generating an interface code as described herein), a UI module 706 (e.g., for generating a payment interface as described herein), an authorization module 708 (e.g., for authorization processes as described herein), and a payment module 710 (e.g., for completing payment transactions as described herein). Although illustrated as separate elements, one or more of modules 702 in FIG. 7 may represent portions of a single module or application.

In certain embodiments, one or more of modules 702 in FIG. 7 may represent one or more software applications or programs that, when executed by a computing device, may cause the computing device to perform one or more tasks. For example, and as will be described in greater detail below, one or more of modules 702 may represent modules stored and configured to run on one or more computing devices, such as the devices illustrated in FIG. 8 (e.g., computing device 802 and/or servers 806A-B). One or more of modules 702 in FIG. 7 may also represent all or portions of one or more special-purpose computers configured to perform one or more tasks.

As illustrated in FIG. 7, example system 700 may also include one or more memory devices, such as memory 740. Memory 740 generally represents any type or form of volatile or non-volatile storage device or medium capable of storing data and/or computer-readable instructions. In one example, memory 740 may store, load, and/or maintain one or more of modules 702. Examples of memory 740 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 7, example system 700 may also include one or more physical processors, such as physical processor 730. Physical processor 730 generally represents any type or form of hardware-implemented processing unit capable of interpreting and/or executing computer-readable instructions. In one example, physical processor 730 may access and/or modify one or more of modules 702 stored in memory 740. Additionally or alternatively, physical processor 730 may execute one or more of modules 702 to facilitate generating/using codeless payment interfaces. Examples of physical processor 730 include, without limitation, microprocessors, microcontrollers, Central Processing Units (CPUs), Field-Programmable Gate Arrays (FPGAs) that implement softcore processors, Application-Specific Integrated Circuits (ASICs), graphics processing units (GPUs), hardware accelerators, co-processors, portions of one or more of the same, variations or combinations of one or more of the same, and/or any other suitable physical processor.

As illustrated in FIG. 7, example system 700 may also include one or more data elements 720, such as an interface code 722 (e.g., corresponding to interface codes described herein), tokens 724 (e.g., corresponding to tokens described herein), and keys 726 (e.g., corresponding to keys described herein), which may be stored on a local storage device, such as memory 740, or may be accessed remotely.

Example system 700 in FIG. 7 may be implemented in a variety of ways. For example, all or a portion of example system 700 may represent portions of example network environment 800 in FIG. 8.

FIG. 8 illustrates an exemplary network environment 800 implementing aspects of the present disclosure. The network environment 800 includes computing device 802, a network 804, and servers 806A-B. Computing device 802 may be a client device or user device, such as a desktop computer, laptop computer, tablet device, smartphone, or other computing device. Computing device 802 may include a physical processor 730, which may be one or more processors, memory 740, which may store data such as one or more of data elements 720, user input devices, and a display.

Servers 806A-B may each represent or include one or more servers capable of generating interface codes, payment interfaces, authorization, and/or payment transactions as described herein (e.g., payment service server 306, payment service server 406, payment service server 506, etc.). Servers 806A-B may include a physical processor 730, which may include one or more processors, memory 740, which may store modules 702, and one or more of additional elements 720.

Computing device 802 may be communicatively coupled to servers 806A-B through network 804. Network 804 may represent any type or form of communication network, such as the Internet, and may comprise one or more physical connections, such as LAN, and/or wireless connections, such as WAN.

FIG. 9 is a flow diagram of an example computer-implemented method 900 for a codeless payment interface. The steps shown in FIG. 9 may be performed by any suitable computer-executable code and/or computing system, including the system(s) illustrated in FIGS. 1, 3A-3B, 7 and/or 8. In one example, each of the steps shown in FIG. 9 may represent an algorithm whose structure includes and/or is represented by multiple sub-steps, examples of which will be provided in greater detail below.

As illustrated in FIG. 9, at step 902 one or more of the systems described herein may generate an interface code configured to connect to a payment server. For example, code module 704 (e.g., corresponding to may generate interface code 722.

The systems described herein may perform step 902 in a variety of ways. In one example, interface code 722 may include an interface identifier that identifies one or more transaction details of the transaction to be completed using the payment interface. For example, the payment server may be able to determine transaction details such as product/service details (of the transaction), payment sources, merchant information, user/agent information, etc. using the identifier. In some examples, the payment server may store, in a table and/or database, the transaction details associated with each unique interface identifier. In some examples, one or more of the transaction details may be encoded in the interface identifier.

At step 904 one or more of the systems described herein may generate, in response to loading a merchant website hosted on a merchant server that integrates the interface code, a payment interface with the interface code. The interface code may bypass the merchant server to connect to the payment server when loading the merchant website. For example, UI module 706 may generate the user interface elements loaded by interface code 722.

The systems described herein may perform step 904 in a variety of ways. In one example, step 904 may include connecting to the payment server (e.g., payment service server 506), identifying product details associated with the merchant website, and customizing the payment interface based on the product details. In some examples, the product details may correspond to at least one of: a product name, a price, a currency, a buyer information, or a merchant information.

In some examples, customizing the payment interface further comprises generating interface elements including at least one of the product name (see, e.g., FIGS. 4A-4B), a quantity selection field, or a customer-entered price field. In some examples, customizing the payment interface further comprises identifying one or more available payment methods, and generating interface elements corresponding to the one or more available payment methods.

In some examples, generating the interface elements further comprises determining locations for the interface elements. For example, the payment service may determine that locations (e.g., globally within the interface and/or relative to other interface elements) for presenting the interface elements. In some examples, the payment service may utilize a recommendation engine (e.g., implemented with AI or machine learning) that may determine what interface elements (e.g., based on available payment methods) and locations thereof for recommending and presenting to the user.

In some examples, customizing the payment interface further comprises generating a shipping interface (see FIG. 4B) and/or generating a tax interface. The shipping interface may provide options/prices for shipping (e.g., based on merchant preferences, location of the product and/or user, etc.) and the tax interface may provide tax information (e.g., based on the user location).

At step 906 one or more of the systems described herein may generate a web token, generate private and public keys associated with the web token, and generate an access token associated with the public key and the identifier. For example, authorization module 708 may generate tokens 724 and/or keys 726 (see also FIG. 5).

At step 908 one or more of the systems described herein may authorize a payment with the payment server using the access token. For example, authorization module 708 may authorize a payment using tokens 724 and keys 726 (see also FIGS. 5 and 6A-6C).

At step 910 one or more of the systems described herein may complete the transaction using the payment interface that bypasses the merchant server to connect to the payment server. For example, payment module 710 may complete the payment transaction (e.g., purchase, see e.g., FIGS. 4A-4B and 6A-6C).

In some aspects, the techniques described herein relate to a computer-implemented method including: generating an interface code configured to connect to a payment server; generating, in response to loading a merchant website hosted on a merchant server that integrates the interface code, a payment interface with the interface code, wherein the interface code bypasses the merchant server to connect to the payment server; and completing a transaction using the payment interface that bypasses the merchant server to connect to the payment server.

In some aspects, the techniques described herein relate to a computer-implemented method, wherein the interface code includes an interface identifier that identifies one or more transaction details of the transaction.

In some aspects, the techniques described herein relate to a computer-implemented method, wherein completing the transaction includes: generating a web token; generating private and public keys associated with the web token; generating an access token associated with the public key and the interface identifier; and authorizing a payment for the transaction with the payment server using the access token.

In some aspects, the techniques described herein relate to a computer-implemented method, wherein generating the payment interface includes: connecting to the payment server; identifying product details associated with the merchant website; and customizing the payment interface based on the product details.

In some aspects, the techniques described herein relate to a computer-implemented method, wherein the product details correspond to at least one of: a product name, a price, a currency, a buyer information, or a merchant information.

In some aspects, the techniques described herein relate to a computer-implemented method, wherein customizing the payment interface further includes generating interface elements including at least one of: the product name; a quantity selection field; or a customer-entered price field.

In some aspects, the techniques described herein relate to a computer-implemented method, wherein customizing the payment interface further includes: identifying one or more available payment methods; and generating interface elements corresponding to the one or more available payment methods.

In some aspects, the techniques described herein relate to a computer-implemented method, wherein generating the interface elements further includes determining locations for the interface elements.

In some aspects, the techniques described herein relate to a computer-implemented method, wherein customizing the payment interface further includes generating a shipping interface.

In some aspects, the techniques described herein relate to a computer-implemented method, wherein customizing the payment interface further includes generating a tax interface.

In some aspects, the techniques described herein relate to a system including: at least one physical processor; and physical memory including computer-executable instructions that, when executed by the physical processor, cause the physical processor to: request a payment interface from a payment server; generate private and public keys associated with the payment interface; generate an access token associated with the public key; provide the access token and the public key to the payment server; and authorize a payment with the payment server from the payment interface using the access token.

In some aspects, the techniques described herein relate to a system, wherein the instructions further cause the physical processor to request the payment interface in response to loading a product page.

In some aspects, the techniques described herein relate to a system, wherein the instructions for requesting the payment interface further includes instructions that cause the processor to: identify product information corresponding to the product page; and receive interface elements for the payment interface based on the product information.

In some aspects, the techniques described herein relate to a system, wherein the instructions for requesting the payment interface further includes instructions that cause the processor to: identify party information corresponding to the product page; and receive interface elements for the payment interface based on the party information.

In some aspects, the techniques described herein relate to a system, wherein the instructions for requesting the payment interface further includes instructions that cause the processor to: identify one or more payment methods available for the product page; and receive interface elements for the one or more payment methods.

In some aspects, the techniques described herein relate to a system, wherein the instructions for requesting the payment interface further includes instructions that cause the processor to: identify a shipping information for the product page; and receive a shipping interface based on the shipping information.

In some aspects, the techniques described herein relate to a system, wherein the instructions for requesting the payment interface further includes instructions that cause the processor to receive a location of one or more interface elements for the payment interface that is determined based on the product page.

In some aspects, the techniques described herein relate to a non-transitory computer-readable medium including one or more computer-executable instructions that, when executed by at least one processor of a computing device, cause the computing device to: detect a first party loading a website of a second party; generate, in response to the detecting, a dynamic interface for a transaction with a third party; and provide the dynamic interface for loading with the website of the second party.

In some aspects, the techniques described herein relate to a non-transitory computer-readable medium, wherein the instructions further cause the computing device to provide the dynamic interface directly from the third party independently from the website of the second party.

In some aspects, the techniques described herein relate to a non-transitory computer-readable medium, wherein the instructions further cause the computing device to: receive, from the second party, a public key and a web token associated with the website; generate and store an access token based on the public key and the web token; provide, to the second party, the access token; and complete the transaction by receiving the access token from the second party.

As detailed above, the computing devices and systems described and/or illustrated herein broadly represent any type or form of computing device or system capable of executing computer-readable instructions, such as those contained within the memory devices described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), hardware accelerators, graphics processing units (GPUs), co-processors, portions of one or more of the same, variations or combinations of one or more of the same, or any other suitable physical processor.

Although described/illustrated as separate elements, the instructions described and/or illustrated herein may represent portions of a single instruction, code, program, and/or application. In addition, in certain embodiments one or more of these instructions may represent one or more software applications or programs that, when executed by a computing device, may cause the computing device to perform one or more tasks. For example, one or more of the instructions described and/or illustrated herein may represent instructions stored and configured to run on one or more of the computing devices or systems described and/or illustrated herein. One or more of these instructions may also represent all or portions of one or more special-purpose computers configured to perform one or more tasks.

In addition, one or more of the modules described herein may transform data, physical devices, and/or representations of physical devices from one form to another. For example, one or more of the instructions recited herein may receive product data to be transformed, transform the product data into interface code, output a result of the transformation to render an interface, use the result of the transformation to complete a transaction with the interface, and store the result of the transformation to dynamically generate the interface. Additionally or alternatively, one or more of the instructions recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
generating an interface code configured to connect to a payment server;
generating, in response to loading a merchant website hosted on a merchant server that integrates the interface code, a payment interface with the interface code, wherein the interface code bypasses the merchant server to connect to the payment server; and
completing a transaction using the payment interface that bypasses the merchant server to connect to the payment server.

2. The computer-implemented method of claim 1, wherein the interface code includes an interface identifier that identifies one or more transaction details of the transaction.

3. The computer-implemented method of claim 2, wherein completing the transaction includes:
generating a web token;
generating private and public keys associated with the web token;
generating an access token associated with the public key and the interface identifier; and
authorizing a payment for the transaction with the payment server using the access token.

4. The computer-implemented method of claim 1, wherein generating the payment interface comprises:
connecting to the payment server;
identifying product details associated with the merchant website; and
customizing the payment interface based on the product details.

5. The computer-implemented method of claim 4, wherein the product details correspond to at least one of: a product name, a price, a currency, a buyer information, or a merchant information.

6. The computer-implemented method of claim 5, wherein customizing the payment interface further comprises generating interface elements including at least one of:
the product name;
a quantity selection field; or
a customer-entered price field.

7. The computer-implemented method of claim 4, wherein customizing the payment interface further comprises:
identifying one or more available payment methods; and
generating interface elements corresponding to the one or more available payment methods.

8. The computer-implemented method of claim 7, wherein generating the interface elements further comprises determining locations for the interface elements.

9. The computer-implemented method of claim 4, wherein customizing the payment interface further comprises generating a shipping interface.

10. The computer-implemented method of claim 4, wherein customizing the payment interface further comprises generating a tax interface.

11. A system comprising:
at least one physical processor; and
physical memory comprising computer-executable instructions that, when executed by the physical processor, cause the physical processor to:
request a payment interface from a payment server;
generate private and public keys associated with the payment interface;
generate an access token associated with the public key;
provide the access token and the public key to the payment server; and
authorize a payment with the payment server from the payment interface using the access token.

12. The system of claim 11, wherein the instructions further cause the physical processor to request the payment interface in response to loading a product page.

13. The system of claim 12, wherein the instructions for requesting the payment interface further comprises instructions that cause the processor to:
identify product information corresponding to the product page; and
receive interface elements for the payment interface based on the product information.

14. The system of claim 12, wherein the instructions for requesting the payment interface further comprises instructions that cause the processor to:
identify party information corresponding to the product page; and
receive interface elements for the payment interface based on the party information.

15. The system of claim 12, wherein the instructions for requesting the payment interface further comprises instructions that cause the processor to:
identify one or more payment methods available for the product page; and
receive interface elements for the one or more payment methods.

16. The system of claim 12, wherein the instructions for requesting the payment interface further comprises instructions that cause the processor to:
identify a shipping information for the product page; and
receive a shipping interface based on the shipping information.

17. The system of claim 12, wherein the instructions for requesting the payment interface further comprises instructions that cause the processor to receive a location of one or more interface elements for the payment interface that is determined based on the product page.

18. A non-transitory computer-readable medium comprising one or more computer-executable instructions that, when executed by at least one processor of a computing device, cause the computing device to:
detect a first party loading a website of a second party;
generate, in response to the detecting, a dynamic interface for a transaction with a third party; and
provide the dynamic interface for loading with the website of the second party.

19. The non-transitory computer-readable medium of claim 18, wherein the instructions further cause the computing device to provide the dynamic interface directly from the third party independently from the website of the second party.

20. The non-transitory computer-readable medium of claim 18, wherein the instructions further cause the computing device to:
receive, from the second party, a public key and a web token associated with the website;
generate and store an access token based on the public key and the web token;
provide, to the second party, the access token; and
complete the transaction by receiving the access token from the second party.
